(19) United States
(12) Patent Application Publication
(10) Pub. No.: US 2023/0287527 A1
(43) Pub. Date: Sep. 14, 2023

(54) RETANNING AND FATLIQUORING COMPOSITIONS COMPRISING A HEMP OIL DERIVATIVE

(71) Applicant: UNIQUE S.R.L., Fucecchio (FI) (IT)

(72) Inventor: Giacomo Monteverde, Fucecchio (FI) (IT)

(73) Assignee: UNIQUE S.R.L., Fucecchio (FI) (IT)

(21) Appl. No.: 18/040,525

(22) PCT Filed: Aug. 4, 2021
(86) PCT No.: PCT/IB2021/057125

§ 371 Date: Feb. 3, 2023

(30) Foreign Application Priority Data
Aug. 7, 2020 (IT) 102020000019696

(51) Int. Cl. C14C 3/12; C14C 9/02

(52) U.S. Cl. CPC C14C 3/12; C14C 9/02

(57) ABSTRACT

The invention concerns the use of a hemp oil derivative in at least one step of the leather working process in the tanning industry, wherein said hemp oil derivative is selected from the group consisting of sulphated hemp oil, sulphited hemp oil, phosphated hemp oil and mixtures thereof. The invention also concerns a composition comprising: a hemp oil derivative selected from the group consisting of sulphated hemp oil, sulphited hemp oil, phosphated hemp oil and mixtures thereof, and—a phosphated (C₈-C₂₄) fatty alcohol having from 1 to 2 hydroxyl groups.

### FIELD OF THE INVENTION

The invention concerns new retanning and fatliquoring compositions for use in the tanning industry.

### STATE OF THE ART

The tanning industry notoriously uses a large variety of chemical products; the transformation of animal skins into marketable leather requires, in fact, a large number of treatments.

The initial steps of the process typically consist of soaking, liming, hair removal, fleshing and possible splitting, deliming, bating and pickling, which are carried out with the aim of cleaning skin from hair, slaughtering residues and unwanted layers of epidermis and fat, bring it to the right thickness, as well as prepare it for the subsequent tanning step.

Tanning essentially consists in impregnating the skins with substances that irreversibly fix on to them and prevent their putrefaction without altering their softness and flexibility. There are many substances that can serve this purpose; among those most commonly used industrially we find, for example, natural tannins, synthetic tannins, chromium salts, aluminium salts, zirconium salts, marine animal oils and formaldehyde.

After the tanning step, the leather is subjected to a retanning step. In recent years, with the evolution of leather working methods, retanning has assumed, together with fatliquoring, a decisive importance. The retanning step, in fact, serves to provide leather with greater mechanical resistance and uniformity, but also softness, elasticity and lightness. In practice, retanning is fundamental in determining the high quality of the leather and some of its final characteristics. In the case of chrome tanned leathers, in particular, retanning allows to provide them with even greater fullness.

The leathers are then subjected to a dyeing step, or to a colouring process with colouring substances of natural or synthetic origin, which aims to improve their appearance, to make them more suitable for manufacturing the articles they are intended to be used for, of increase their quality and therefore their commercial value.

After dyeing, the leathers are subjected to fatliquoring, i.e. a treatment that lubricates them, to prevent the fibres from joining together causing defects, and provides them with softness, wear resistance, tear resistance, elasticity and soft touch.

The tanning, retanning, dyeing and finally fatliquoring steps are therefore fundamental steps in the leather working process, during which the final characteristics are determined and provided to the leather.

This industrial sector is therefore constantly looking for new products that can be used in these steps of the tanning process and allow to modulate the properties of the finished products as desired.

In recent years, there has been a lot of effort in particular to use products of increasingly natural derivation in the tanning processes, with connotations of greater sustainability in terms of environmental impact, less and less aggressive in terms of potential irritating/allergenic effects due to residues thereof retained in the leather after processing, as well as preferably obtainable from waste materials of other industrial processes in order to also pursue circular economy logics.

For example, the International Patent Application No. WO2018/025210 describes the use of olive oil mill waste waters, a waste product from oil mills with a high environmental impact, as an innovative retanning agent to be used in the tanning industry in place of the traditional and polluting metal tanning agents, such as chromium.

The Italian Patent Application No. 102012902059846 describes instead a new leather dyeing process with natural dyes, completely free from use of metals.

Many lines of research are therefore active in the direction of identifying new compositions with properties suitable for use in the tanning industry, which allow to carry out the leathers treatment with less chemically aggressive methods and at the same time lead to valuable finished leathers, suitable for the market.

The primary aim of the present invention is therefore to identify new compositions of natural origin and low environmental impact for use in the tanning industry.

### SUMMARY OF THE INVENTION

The inventors have in fact surprisingly discovered that they could use hemp oil in the tanning sector, obtaining surprising results in some steps of the process through a derivatization of the same oil. Unlike other vegetable oils widely used in tanneries, hemp oil cannot be used per se, due to its high content of particularly drying ricinoleic fatty acids, which do not allow an adequate penetration thereof into the leather fibres. In fact, when used on leather, hemp oil remains on the surface, leaving a poorly acceptable and pleasant oily film.

Surprisingly, the inventors have found that specific hemp oil derivatives could be used in the leather working process steps and, in particular, exhibited excellent retanning and fatliquoring activities on the leathers, and surprisingly favoured leather dyeing.

In a first aspect, the invention therefore concerns the use of a hemp oil derivative in at least one step of the leather working process in the tanning industry, wherein said hemp oil derivative is selected from the group consisting of sulphated hemp oil, sulphited hemp oil, phosphated hemp oil and mixtures thereof.

In a first embodiment, the invention concerns the use of said hemp oil derivative in a step of the leather working process in the tanning industry, which is the retanning step.

In a second embodiment, the invention relates to the use of said hemp oil derivative in a step of the leather working process in the tanning industry, which is the fatliquoring phase.

In an advantageous and preferred aspect, the invention involves the use of a phosphated (C₈-C₂₄) fatty alcohol having from 1 to 2 hydroxyl groups together with said hemp oil derivative selected from the group consisting of sulphated hemp oil, sulphited hemp oil, phosphated hemp oil and mixtures thereof.

The invention therefore also concerns a composition comprising:
a hemp oil derivative selected from the group consisting of sulphated hemp oil, sulphited hemp oil, phosphated hemp oil and mixtures thereof, and
a phosphated (C₈-C₂₄) fatty alcohol having from 1 to 2 hydroxyl groups.

### DESCRIPTION OF THE FIGURES

FIG. 1 shows the comparison between the FT-IR spectrum of crude hemp oil and that of sulphated hemp oil of Example 1 (the appearance of the specific peak at about 1235 cm⁻¹ is an indication of sulphation).

### DETAILED DESCRIPTION OF THE INVENTION

The invention concerns the use of a hemp oil derivative in at least one step of the leather working process in the tanning industry, wherein said hemp oil derivative is selected from the group consisting of sulphated hemp oil, sulphited hemp oil, phosphated hemp oil and mixtures thereof.

Hemp oil is typically obtained from Cannabis sativa seeds by cold pressing. It is a vegetable oil rich in essential fatty acids with strong antioxidant, immunomodulating and anti-inflammatory properties.

The inventors have now surprisingly discovered that some specific hemp oil derivatives could be used in steps of the tanning industry.

According to the invention, the hemp oil derivative is selected from the group consisting of sulphated hemp oil, sulphited hemp oil, phosphated hemp oil and mixtures thereof.

These derivatives can be obtained according to any ordinary method of the prior art that allows sulphation, sulphitation or phosphation of fatty acids contained in hemp oil.

A typical hemp oil fatty acid composition is shown in the examples included herein.

According to the invention, hemp oil is then sulphated, sulphited and phosphated according to techniques known in the market for the reaction of sulphation, sulphitation and for the phosphation of carboxylic groups.

Preferably, the sulphated hemp oil derivative can be obtained by sulphation reaction with sulphuric acid having an acid concentration from 94 to 98%, more preferably for a time from 30 to 180 minutes and at a reaction temperature from 15 to 40° C., even more preferably at 20° C. for 120 minutes.

Advantageously, following the sulphation reaction, the sulphated derivative is subjected to washing, preferably with a washing solution comprising water, potassium hydroxide and sodium chloride. The washing can take place at a temperature from 20° C. to 70° C., preferably at 45° C.

Once separated from the washing liquid, the sulphated hemp oil derivative can be neutralised, advantageously with triethanolamine.

The sulphated and neutralised derivative can advantageously be formulated in a composition comprising additives, such as for example fungicides and antioxidants.

Specifically, said sulphation, sulphitation or phosphation processes allow a degree of sulphation, sulphitation and phosphation of at least 1%, meaning by this the percentage by weight of bound sulphated, sulphited or phosphated groups, present after the reaction, with respect to the total weight of the hemp oil obtained at the end of the reaction.

Preferably the hemp oil derivative has a weight percentage of sulphated, sulphited and phosphated groups in the range from 0.5 to 10, with respect to the total weight of hemp oil.

Preferably said hemp oil derivative is sulphated hemp oil.

Even more preferably, said sulphated hemp oil has a degree of sulphation expressed as a percentage of sulphated groups in the range from 2 to 10% by weight, more preferably from 2.5% to 6.5% by weight, with respect to the total weight of hemp oil.

The inventors also surprisingly discovered that said specific hemp oil derivatives specifically showed excellent retanning properties.

In a first embodiment, the invention therefore concerns the use of said hemp oil derivative in a step of the leather working process in the tanning industry, which is the retanning step.

The inventors also tested said specific hemp oil derivatives in the fatliquoring step and discovered that, unlike hemp oil per se, they had excellent fatliquoring properties.

In a second embodiment, the invention therefore concerns the use of said hemp oil derivative in a step of the leather working process in the tanning industry, which is the fatliquoring step.

In an advantageous and surprising aspect, the use of the hemp oil derivative of the invention takes place in combination with a phosphated (C₈-C₂₄) fatty alcohol having from 1 to 2 hydroxyl groups.

As will be apparent from the following experimental part, in fact, the inventors surprisingly discovered that, when the sulphated hemp oil was used together with a phosphated fatty alcohol, the retanning and fatliquoring properties of the composition increased enormously and the properties of the treated leather reached the highest standards.

The use of phosphated fatty alcohol in combination with the hemp oil derivative can take place through preliminary preparation of a composition containing them or can take place sequentially, in any order.

In a further aspect, therefore, the invention concerns a composition comprising:
a hemp oil derivative selected from the group consisting of sulphated hemp oil, sulphited hemp oil, phosphated hemp oil and mixtures thereof, and
a phosphated (C₈-C₂₄) fatty alcohol having from 1 to 2 hydroxyl groups.

These compositions resulted to be more easily emulsifiable in water and therefore were able to better penetrate the leather fibres, uniformly throughout the section thereof, producing a full, round, and rubbery leather, pleasant to the touch, with a silky appearance, with an intense and deep colour.

The phosphated (C₈-C₂₄) fatty alcohol having from 1 to 2 hydroxyl groups present in the composition, and used according to the invention, is preferably in the form of a salt. More preferably, the phosphated (C₈-C₂₄) fatty alcohol salt is phosphated (C₈-C₂₄) fatty alcohol triethanolamine (TEA).

Preferably, the composition comprises the sulphated hemp oil derivative in a concentration from 35 to 99% by weight, and the phosphated (C₈-C₂₄) fatty alcohol in a concentration from 1 to 30% by weight. The composition of the invention may further contain additives.

The composition of the invention may contain additives useful for the final formulation, preferably ethoxylated castor oil, isopropyl alcohol, and butyl glycol. In another aspect, therefore, the invention relates to the use of the composition of the invention in at least one step of the leather working process in the tanning industry, preferably in the retanning and/or fatliquoring and/or dyeing steps.

The fatliquoring and retanning properties of the hemp oil derivative and composition comprising the sulphated hemp oil and phosphated fatty alcohol of the invention were tested with good results. As will be apparent from the following experimental part, the use according to the invention of the hemp oil derivative and composition of the invention produced treated leathers that had better aesthetic properties, also for colour definition ad for touch compared to leathers treated with known products.

The compositions comprising sulphated hemp oil and a phosphated fatty alcohol also proved to be particularly advantageous, as will be apparent from the following experimental part.

### EXPERIMENTAL PART

### Example 1—Synthesis of Sulphated Hemp Oil

1000 g of hemp oil, whose fatty acid composition is shown in the following Table 1, were subjected to a sulphation reaction by treatment with 180 g of 96% sulphuric acid at room temperature (about 20° C.).

TABLE 1
Fatty acids content, expressed as a percentage by weight
with respect to the total weight of hemp oil analysed,
determined by gas-chromatographic analysis.

| Fatty Acid | Content (%) |
|---|---|
| Lauric Acid | ≤0.2 |
| Myristic Acid | ≤0.3 |
| Palmitic Acid | 4.0-10.0 |
| Palmitoleic Acid | ≤0.05 |
| Margaric Acid | ≤0.01 |
| Margaroleic Acid | ≤0.01 |
| Stearic Acid | 1.0-4.0 |
| Oleic Acid | 6.0-20.0 |
| Linoleic Acid | 45.0-65.0 |
| α-Linolenic Acid | 14.0-28.0 |
| γ-Linolenic Acid | ≤4 |
| Arachidic Acid | ≤2 |
| Eicosenoic Acid | ≤1.5 |
| Behenic Acid | ≤1 |
| Erucic Acid | ≤1 |
| Lignoceric Acid | ≤0.5 |
| (trans) Oleic Acid | ≤1 |
| (trans) Linoleic Acid | ≤1.5 |
| (trans) Linolenic Acid | ≤1 |

The sulphation reaction was carried out under slow stirring for about 2 hours, obtaining an acidic hemp oil mixture.

Subsequently, this acidic hemp oil mixture was added, at a temperature of about 45° C., to a washing solution consisting of 1500 g of water, 280 g of 50% potassium hydroxide and 500 g of 100% sodium chloride, keeping all under stirring for about 5 minutes.

The mixture was then kept at a temperature of about 45° C. for a further 15 hours until complete separation of the phases.

The upper oily phase, consisting of aqueous sulphated hemp oil, was then subjected to neutralisation; specifically, 1150 g of aqueous 90% sulphated hemp oil were reacted with 30 g of 80% triethanolamine, at a temperature of about 25° C. and for a time of about 10 minutes.

At the end of the neutralisation reaction, a fairly clear brown/greenish oil was obtained, with a degree of sulphation, expressed as a percentage by weight of sulphate group of about 4.4%, with respect to the total weight of the hemp oil obtained.

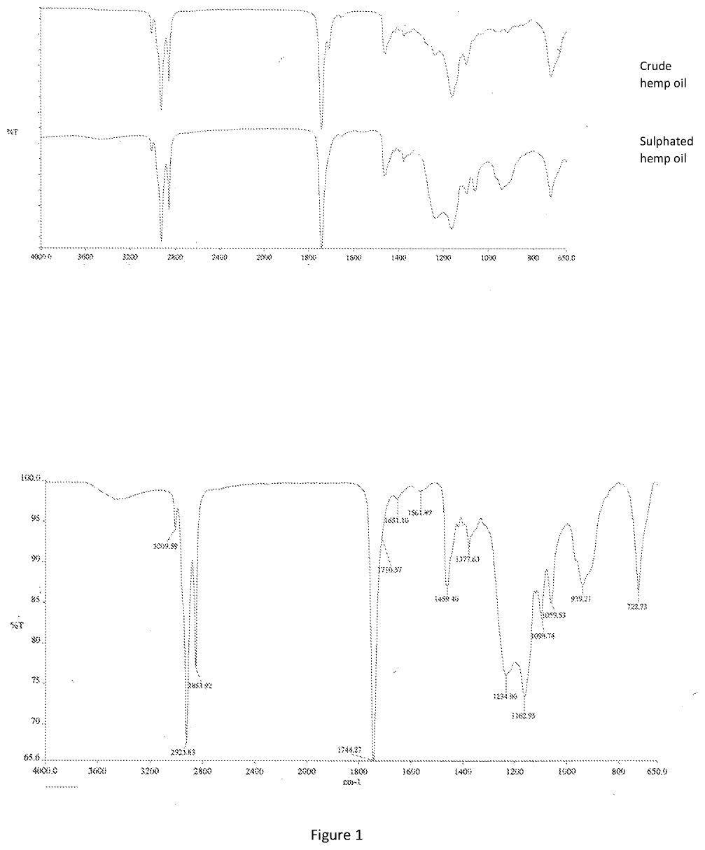

The FT-IR spectrum carried out on the crude hemp oil and the sulphated oil thus obtained, as compared in FIG. 1, confirmed that the sulphation reaction occurred. The appearance of the specific peak at about 1235 cm⁻¹ is an indication that the sulphation occurred.

### Example 2—Synthesis of Sulphited Hemp Oil Derivative

Example 1 for the synthesis of the sulphated hemp oil derivative was repeated but using sodium bisulphite instead of sulphuric acid. An oil was thus obtained with a degree of sulphitation of about 5% with respect to the total weight of the hemp oil obtained.

### Example 3—Synthesis of Phosphated Hemp Oil Derivative

Example 1 for the synthesis of the sulphated hemp oil derivative was repeated but using phosphoric acid instead of sulphuric acid. An oil was thus obtained with a degree of phosphation of about 3% with respect to the total weight of the hemp oil obtained.

### Example 4—Preparation of the Composition Comprising the Sulphated Hemp Oil Derivative

The sulphated derivative of Example 1 was stabilized by preparing a composition suitable for application on leathers. Specifically, to 1150 g of the sulphated hemp oil derivative from Example 1, at a temperature of about 25° C., 30 g of triethanolamine, 3 g of the antioxidant compound BHT (butoxylated hydroxytoluene) at 100%, 1 g of a 50/50 by weight MIT/BIT (Methylisothiazolinone/Benzylisothiazolinone) fungicidal mixture at 20%, 60 g of 100% butyl glycol and finally 200 g of water were added, under stirring for about 10 minutes, obtaining at the end of the mixing an off-white aqueous emulsion.

### Example 5—Preparation of the Composition According to the Invention Comprising a Sulphated Hemp Oil and a Phosphated Fatty Alcohol Salified with Triethanolamine (TEA)

725 g of the sulphated derivative of Example 1 were mixed at a temperature of 20° C. with 80 g of a 50/50 mixture of phosphated (C₁₆-C₁₈) fatty alcohols as triethanolamine salt, 10 g of ethoxylated castor oil, 5 g of isopropyl alcohol, 10 g of butyl glycol and 170 g of water. Mixing was carried out for a time of about half an hour.

The final composition obtained had a pH of about 6.5 and a viscosity of 1230 m·Pas. The degree of phosphation of the final composition was 3010 mg of P per kg of final composition, corresponding to 0.92% PO₄, and the degree of sulphation was 19400 mg of S per kg of final composition, corresponding to 4.85% SO₃.

### Example 6—Use of the Composition of the Invention in the Fatliquoring, Retanning and Dyeing Steps in Comparison with Known Compositions

The composition of the invention of Example 4 was used on wet-blue tanned calfskin, in the vegetal retanning, fatliquoring and dyeing steps.

Specifically, the composition of the invention was used in the retanning, fatliquoring and dyeing steps instead of known retanning and fatliquoring compositions.

Treatment a with Composition of Example 4

In this experiment, the composition 4 of the invention was used to replace the known retanning and fatliquoring agent used in the traditional recipe.

The leathers were initially treated for 60 minutes with water, acetic acid, oxalic acid and NEMOLIX HH (a degreasing additive) and then subjected to draining and washing. Subsequently, the leathers were treated with water, acetic acid, and Correctan NSA (synthetic retanning agent) for 30 minutes followed by a treatment step with Correctan KGB/SS (synthetic retanning agent), Suppletan TH/SS (chrome retanning agent), BAYCROM FD (chrome retanning agent) and DERMAGAN (Sulpho Chloro Paraffin, fatliquor) for 60 minutes. The leathers thus treated were then treated with water, sodium acetate and sodium bicarbonate for 180 minutes, and then subjected to draining and washing. At that point the leathers were treated with water and with the composition of Example 4 of the invention for about 120 minutes. The leathers treated with the composition of the invention were then treated with NEMOTAN AUTO/SS (retanning agent), SUPPLETAN RB/SS (filling resin) and CORRECTAN GN (synthetic retanning agent) for 90 minutes. This treatment was followed by a treatment with formic acid for 30 minutes, and then draining and cooling. The last treatments on the leathers consisted of a treatment with water, SUPPLETAN MLR (synthetic tannin dyeing auxiliary) and dye for 45 minutes, and again a treatment with formic acid and water for a further 30 minutes. The leathers thus obtained were then drained and cooled and then set out under vacuum.

Treatment B with a Known Composition

The leathers were treated in the same way and with the same ingredients of treatment A with the composition of Example 4. The only difference was the use, in place of the composition of Example 4 of the invention, of the product Hydroil as retanning agent and of the well-known traditional products Coriol 727 (phosphoric ester fatliquor), Nemostop 42 (fatliquor), Coriol 453 (lecithin fatliquor), Dermagan (lecithin fatliquor), Belipon OC (soap), as fatliquoring agents.

Treatment C with the Composition of Example 4

The leathers were treated in the same way and with the same ingredients of treatment B. The only difference was the use of the composition of Example 4 of the invention instead of the known Hydroil retanning product, in order to better evaluate the retanning properties of the composition of the invention.

Results

The leathers treated as indicated above were evaluated for external appearance, touch, and texture.

The leathers subjected to treatment A with the composition of Example 4 appeared firm with full hand and excellent dyeing yield compared to leathers treated with the known treatment B. The leathers treated with treatment B (corresponding to a standard retanning, fatliquoring and dyeing recipe) were less firm and the colour rendering on the leather surface resulted worse than treatment A. This comparison demonstrated both the excellent retanning/filling properties and the fatliquoring/lubricating effect of the composition of Example 4 which contained the hemp oil derivative.

Treatment C, involving the use of the same fatliquoring substances of treatment B but replacing the known retanning product with the composition of the invention, allowed to obtain excellent uniformity of dyeing, excellent colour rendering and the leathers were full and at the same time soft. The leathers treated with treatment B (corresponding to a retanning recipe with the Hydroil product) were less firm and the colour rendering on the leather surface was worse than with treatment C. Surprisingly, therefore, the composition of Example 4 containing the hemp oil derivative resulted to be completely emulsifiable and, thanks to its anionic character and penetration into the skin, favoured dyeability of the leathers. The leathers dyed with treatments A and C showed greater colour depth and brilliance, compared to the leather of the known treatment B.

The above results revealed the advantageous effect of using the hemp oil derivative in the tanning process, in particular for the retanning, fatliquoring and dyeing steps.

The composition comprising the hemp oil derivative of Example 4 penetrated rapidly and uniformly throughout the section of the leather, obtaining full, round and rubbery leathers, with completely exhausted used baths.

The composition comprising the hemp oil derivative of Example 4 provided the leather with softness without making it sagging, a pleasant and silky touch, the degree of colour and touch were excellent also on the flesh side.

The internal leather fibres had excellent lubrication, which is essential for passing physical/mechanical tests such as traction, tearing, etc.

The colour was uniform and full, since the composition of Example 4 enhanced the dyeing power of the dyes without highlighting the defects of the dermis.

The table below summarizes the above results for treatments A, B and C. The properties were evaluated with reference to a scale of values from 1 to 10, a higher value being an indication of better property.

| | | Fatliquoring | | Dyeing yield | |
|---|---|---|---|---|---|
| | Filling | Effect/ | | and colour | |
| Treatment | Effect | Softness | Firmness | uniformity | Touch |
| A | 6 | 7.5 | 6 | 8 | 9 |
| B | 5 | 6 | 4 | 4 | 4.5 |
| C | 6 | 7 | 5.5 | 8 | 8.5 |

### Example 7—Use of the Compositions of the Invention in the Fatliquoring, Retanning and Dyeing Steps in Comparison with Known Compositions

The composition of the invention of Example 5 was used on wet-blue tanned calfskin, in the vegetal retanning, fatliquoring and dyeing steps.

Specifically, the composition of the invention comprising, in addition to the sulphated hemp oil derivative, also the phosphated fatty alcohol salified with triethanolamine (TEA) was used in the retanning, fatliquoring and dyeing steps instead of known retanning and fatliquoring compositions.

Treatment a with Composition of Example 5

The leathers were initially treated with water, acetic acid, oxalic acid and NEMOLIX HH (a degreasing additive) for 60 minutes, and then subjected to draining and washing. Subsequently, the leathers were treated with water, acetic acid, and Correctan NSA (synthetic retanning agent) for 30 minutes followed by a treatment step with Correctan KGB/SS (synthetic retanning agent), Suppletan TH/SS (chrome retanning agent), BAYCROM FD (chrome retanning agent) and DERMAGAN (Sulpho Chloro Paraffin, fatliquor) for 60 minutes. The leathers thus treated were then treated with water, sodium acetate and sodium bicarbonate for 180 minutes, and then subjected to draining and washing. At that point, the leathers were treated with water and with the composition of Example 5 for about 120 minutes. The leathers treated with the composition of the invention were then treated with NEMOTAN AUTO/SS (retanning agent), SUPPLETAN RB/SS (filling resin) and CORRECTAN GN (synthetic retanning agent) for 90 minutes. This treatment was followed by a treatment with formic acid for 30 minutes, and then draining and cooling. The last treatments on the leathers consisted of a treatment with water, SUPPLETAN MLR (synthetic tannin dyeing auxiliary) and dye for 45 minutes, and a treatment with formic acid and water for a further 30 minutes. The leathers thus obtained were then drained and cooled, and then set out under vacuum.

Treatment B with a Known Composition

The leathers were treated in the same way and with the same ingredients of treatment A with the composition of Example 5. The only difference was the use, in place of the composition of Example 5 of the invention, of the known product Hydroil as retanning agent and of the known products Coriol 727 (phosphoric ester fatliquor), Nemostop 42 (fatliquor), Coriol 453 (lecithin fatliquor), Dermagan (lecithin fatliquor), Belipon OC (soap), traditionally used as fatliquors.

Treatment C with Composition of Example 5

The leathers were treated in the same way and with the same ingredients of treatment B. The only difference was the use of the composition of Example 5 of the invention instead of the Hydroil compound of the known composition, in order to better evaluate the retanning properties of the composition of the invention.

Treatment D

In this treatment, the fatliquoring properties of the composition of Example 5 of the invention, used as a complete replacement for traditional fatliquors, were tested. The leathers were initially treated with water, acetic acid, oxalic acid and NEMOLIX HH (a degreasing additive) for 60 minutes, and then subjected to draining and washing. Subsequently the leathers were treated with water, formic acid for 10 minutes followed by a treatment step with Cromo 33 (chrome retanning agent) Suppletan TH/SS (chrome retanning agent), CORIOL 727 (phosphoric ester fatliquor) and DERMAGAN (Sulpho Chloro Paraffin, fatliquor) for 60 minutes. The leathers thus treated were then treated with Suppletan Ox (oxazolidine based retanning agent) for 20 minutes, and subsequently with sodium formate, sodium sulphite and sodium bicarbonate for a further 30 minutes. After adding water, Suppletan ANF (filling amphoteric resin) was added for 180 minutes. The leathers were then subjected to draining and washing. At that point the leathers were treated with water and Correctan PC (filling acrylic resin) for 30 minutes, and subsequently with Fuller SA (protein and flour-based filling), the composition of Example 5 of the invention and Belipon OC (soap) for 30 minutes. The leathers treated with the composition of the invention were then treated with NEMOTAN 1200/BV (retanning agent) for 20 minutes, CORRECTAN GN (synthetic retanning agent) and NEMOTAN AUTO/SS (retanning agent) for 20 minutes. This treatment was followed by a treatment with NEMOTAN 2500 (retanning agent) for 90 minutes, and then with formic acid for a further 30 minutes. The leathers were then drained, cooled, dyed and set out under vacuum.

Results

The leathers treated as indicated above were evaluated for external appearance, touch, and texture.

The leathers subjected to treatment A with the composition of Example 5 appeared firm with full hand and excellent dyeing yield compared to leathers treated with the known treatment B. The leathers treated with treatment B (corresponding to a standard retanning, fatliquoring and dyeing recipe) were less firm and the colour rendering on the leather surface was uneven and empty of colour. This comparison demonstrated the excellent retanning/filling properties and the fatliquoring/lubricating effect of the composition of Example 5, which contained the hemp oil derivative and the phosphated fatty alcohol salified with TEA.

Treatment C, involving the use of the same fatliquoring substances as treatment B but replacing the known retanning product with the composition of the invention, made it possible to obtain excellent uniformity of dyeing, excellent colour rendering, and the leather resulted full and soft at the same time. The leathers treated with treatment B (corresponding to a retanning recipe with Hydroil product) were less firm and the colour rendering on the leather surface was worse than with treatment C.

Surprisingly, therefore, the composition of Example 5, containing the hemp oil derivative and the phosphated fatty alcohol salified with TEA, was completely emulsifiable and, thanks to its anionic character and penetrability in the leather, favoured dyeability of the leathers. The leathers dyed with treatments A and C showed greater colour depth and brilliance, compared to the leather of the known treatment B.

Treatment D corresponded to the treatment in which the original fatliquors were replaced with the composition of Example 5. The leather obtained from treatment D was a very firm, full, snappy leather, and at the same time with a good softness. These results are to be considered surprising since the treatment in question, which involves a retanning with very high resin concentrations, has always shown poor dyeability issues. Instead, replacing the fatliquors of the traditional recipe with the composition of Example 5 of the invention, an excellent dyeing yield was obtained, with excellent penetration of the dye inside the fibre.

From the results described above, therefore, the advantageous effect of using the hemp oil derivative together with phosphated and salified fatty alcohol in the tanning process was apparent, in particular for the retanning, fatliquoring, and dyeing steps.

The composition of Example 5 penetrated rapidly and uniformly throughout the section of the leather, obtaining full, round, and rubbery leathers, with completely exhausted used baths.

The composition of Example 5 provided the leather with softness without making it sagging, a pleasant and silky touch, the degree of colour and touch were excellent also on the flesh side.

The internal leather fibres had excellent lubrication, which is essential for passing physical/mechanical tests such as traction, tearing, etc.

The colour was uniform and full, since the composition of Example 5 enhanced the dyeing power of the dyes without highlighting the defects of the dermis.

The inventors also noted that the performance of the composition of Example 5 was better than the performance of the composition of Example 4, except for the touch. The following table summarizes the above results for treatments A, B, C and D. The properties were evaluated with reference to a scale of values from 1 to 10, a higher value being an indication of better property.

| | | Fatliquoring | | Dyeing yield | |
|---|---|---|---|---|---|
| | Filling | Effect/ | | and colour | |
| Treatment | Effect | Softness | Firmness | uniformity | Touch |
| A | 8 | 8 | 7 | 8 | 7.5 |
| B | 5 | 6 | 4 | 4 | 4.5 |
| C | 8 | 8 | 6 | 8 | 7 |
| D | 8 | 8 | 9 | 8 | 6 |

1. A method for leather working in tanning industry comprising at least one step of using a hemp oil derivative, wherein said hemp oil derivative is selected from the group consisting of sulphated hemp oil, sulphited hemp oil, phosphated hemp oil and mixtures thereof.

2. The method according to claim 1, wherein said step of a retanning step.

3. The method according to claim 1, wherein said step a fatliquoring step.

4. The method according to claim 1, wherein the hemp oil derivative is sulphated hemp oil.

5. The method according to claim 4, wherein the sulphated hemp oil has a degree of sulphation in the range from 2 to 10%.

6. The method according to claim 1, wherein the hemp oil derivative is used in combination with a phosphated (C8-C24) fatty alcohol having from 1 to 2 hydroxyl groups.

7. A composition comprising:
a hemp oil derivative selected from the group consisting of sulphated hemp oil, sulphited hemp oil, phosphated hemp oil and mixtures thereof, and
a phosphated (C8-C24) fatty alcohol having from 1 to 2 hydroxyl groups.

8. The composition according to claim 7, wherein the hemp oil derivative is sulphated hemp oil.

9. The composition according to claim 8, wherein the sulphated hemp oil has a degree of sulphation in the range from 2 to 10%.

10. The composition according to claim 7, wherein the phosphated (C8-C24) fatty alcohol having from 1 to 2 hydroxyl groups is in the form of a salt.

11. A method for leather working in tanning industry comprising at least one step of using the composition according to claim 7.

12. The method according to claim 11, wherein said step a retanning step.

13. The method according to claim 11, wherein said step a fatliquoring step.

14. The method according to claim 5, wherein the sulphated hemp oil has a degree of sulphation in the range from 2.5% to 6.5%.

15. The composition according to claim 9, wherein the sulphated hemp oil has a degree of sulphation in the range from 2.5% to 6.5%.

16. The composition according to claim 10, wherein the phosphated (C8-C24) fatty alcohol having from 1 to 2 hydroxyl groups is phosphated (C8-C24) fatty alcohol triethanolamine (TEA).
